(19) United States
(12) Patent Application Publication
(10) Pub. No.: US 2014/0233029 A1
(43) Pub. Date: Aug. 21, 2014

(54) SPECTROMETER

(71) Applicants: Hans-Juergen Dobschal, Kleinromstedt (DE); Jochen Mueller, Jena (DE)

(72) Inventors: Hans-Juergen Dobschal, Kleinromstedt (DE); Jochen Mueller, Jena (DE)

(73) Assignee: Carl Zeiss Microscopy GmbH, Jena (DE)

(21) Appl. No.: 14/236,599

(22) PCT Filed: Jul. 23, 2012
(86) PCT No.: PCT/EP2012/064409

§ 371 Date: Apr. 24, 2014

(30) Foreign Application Priority Data
Aug. 2, 2011 (DE) 102011080276.2

(51) Int. Cl. G01J 3/02; G01J 3/18

(52) U.S. Cl. CPC G01J 3/0256; G01J 3/18
USPC 356/328

(57) ABSTRACT

A spectrometer with a detector and a transparent body which has an entry area and an exit area on a front side of the body and a reflection grating on a rear side of the body. A beam entering the body via the entry area is reflected at the reflection grating to the exit area and in the process is spectrally split and passes through the exit area and impinges on the detector. The rear side is curved at least in the region of the reflection grating in such a way that the beam is focused in the horizontal and vertical planes when it is reflected at the reflection grating.

### PRIORITY CLAIM

The present application is a National Phase entry of PCT Application No. PCT/EP2012/064409, filed Jul. 23, 2012, which claims priority from German Application Number 102011080276.2, filed Aug. 2, 2011, the disclosures of which are hereby incorporated by reference herein in their entirety.

### FIELD OF THE INVENTION

The present invention relates to a spectrometer, in particular a compact spectrometer.

### BACKGROUND OF THE INVENTION

Spectrometers are used in a large number of applications, from routine analysis in the laboratory, through process measurement technology, to quality assurance in manufacturing. Many of these spectrometers, however, have the disadvantage that they consist of a large number of optical and mechanical components which require a high outlay for assembly and adjustment, with the result that cost-effective manufacture is often not possible.

### SUMMARY OF THE INVENTION

Starting from here, the object of the invention is to provide a spectrometer which is compact, requires a low outlay for adjustment and assembly and has good optical performance parameters.

The object is achieved by a spectrometer with a detector and a transparent body, which has an entry area and an exit area on a front side of the body and a reflection grating on a rear side of the body, wherein a beam entering the body via the entry area is reflected at the reflection grating to the exit area and in the process is spectrally split and passes through the exit area and impinges on the detector, and wherein the rear side is curved at least in the region of the reflection grating in such a way that the beam is focused in the horizontal and vertical planes when it is reflected at the reflection grating.

As the reflection grating focuses both in the horizontal and the vertical plane and therefore has imaging properties, the number of optical components can be reduced. Furthermore, the spectrometer is extremely compact as all optically effective surfaces are formed on the transparent body or its front and rear side. This keeps the outlay on adjustment and assembly extremely low and the proportion of scattered light is relatively low.

The transparent body is formed in particular as a monolithic body and can, e.g., be produced cost-effectively (in particular in comparison with individually constructed spectrometers) by a simple molding process, such as for example, injection molding or injection compression molding.

The spectrometer according to the invention has a high resolution and at the same time has a high entry aperture.

The horizontal plane is preferably the plane in which the reflection grating brings about the spectral splitting.

In the spectrometer according to the invention, the exit area can focus the beam in the horizontal and the vertical plane as it passes through. The exit area can thereby also be used in particular as a correction surface with which imaging errors of the spectrometer, which in particular are caused by the reflection grating, can be compensated for. The exit area can thus reduce, for example, astigmatism and/or spectral field curvature. It can do this close to the image field in an advantageous manner.

The exit area can in particular be formed as a free-form surface. A free-form surface herein means a curved surface which is neither a sphere nor a rotationally symmetrical asphere.

The entry area can be at a distance from the exit area or at least partially penetrate it. In particular it is possible that the entry area and the exit area are part of the same surface, e.g., the same free-form surface. Of course, alternatively (in particular when the entry and exit areas are at a distance from one another) the entry area can have a surface shape which is independent of the exit area and can be separately optimized, to ensure that the spectrometer has the best possible optical performance parameters. In particular, the entry area can be formed as a planar surface.

In the spectrometer according to the invention, the beam path of the beam is folded exactly once from the entry area via the reflection grating to the exit area. This folding is achieved by reflection at the reflection grating.

The rear side of the transparent body is formed as a sphere, as a rotationally symmetrical asphere or as a free-form surface at least in the region of the reflection grating. If the formation is present as a free-form surface, there are additional degrees of freedom for optimizing the optical performance parameters of the spectrometer.

The reflection grating is in particular formed as a blazed diffraction grating. As the grating is used as a rear side grating, the blaze maximum is shifted by approximately the factor n (n=refractive index of the transparent medium and can, e.g., be 1.5) to higher wavelengths, which allows for practical application in many cases.

The transparent body with the curved front and rear side and the blazed structure of the reflection grating can be produced relatively easily by a molding process, such as, e.g., injection molding or injection compression molding. This production process makes it possible, e.g., in a cost-effective way to produce the front side, e.g., with the free-form surface for the exit area, the rear side, e.g., with the spherical surface or the free-form surface in the region of the reflection grating as well as the grating structures of the reflection grating, in a single work step.

The reflection grating can for example be formed as a holographic grating which can be produced using a holographic standing wave process. A deformed wavefront can, e.g., be used whereby there is an additional degree of freedom of correction to improve the imaging.

The spectrometer according to the invention can be formed as a multi-channel spectrometer, wherein the channels lie one on top of the other in a vertical direction. In this case, the detector is preferably formed as a surface detector, with the result that it can simultaneously receive all channels spectrally resolved.

The spectrometer according to the invention is in particular designed for wavelengths from the visible wavelength range, i.e., for electromagnetic radiation with a wavelength in the range of 380-780 nm. In particular the spectrometer according to the invention can additionally or alternatively be designed for the UV range and/or the IR range.

The spectrometer can have a housing in which the detector and the transparent body are arranged. The entrance slit can be formed on a wall of the housing.

It is understood that the features mentioned above and those yet to be explained below can be used, not only in the stated combinations, but also in other combinations or alone, without departing from the scope of the present invention.

### BRIEF DESCRIPTION OF THE DRAWINGS

The invention is explained in further detail below by way of example with reference to the attached drawings which also disclose features essential to the invention. There are shown in:

FIG. 1 a schematic view of an embodiment of the spectrometer according to the invention;

FIG. 2 a schematic representation of the entrance slit of the spectrometer in the case of a formation as a multi-channel spectrometer, and

FIG. 3 a schematic representation of the detector in the case of the formation as a multi-channel spectrometer.

### DETAILED DESCRIPTION

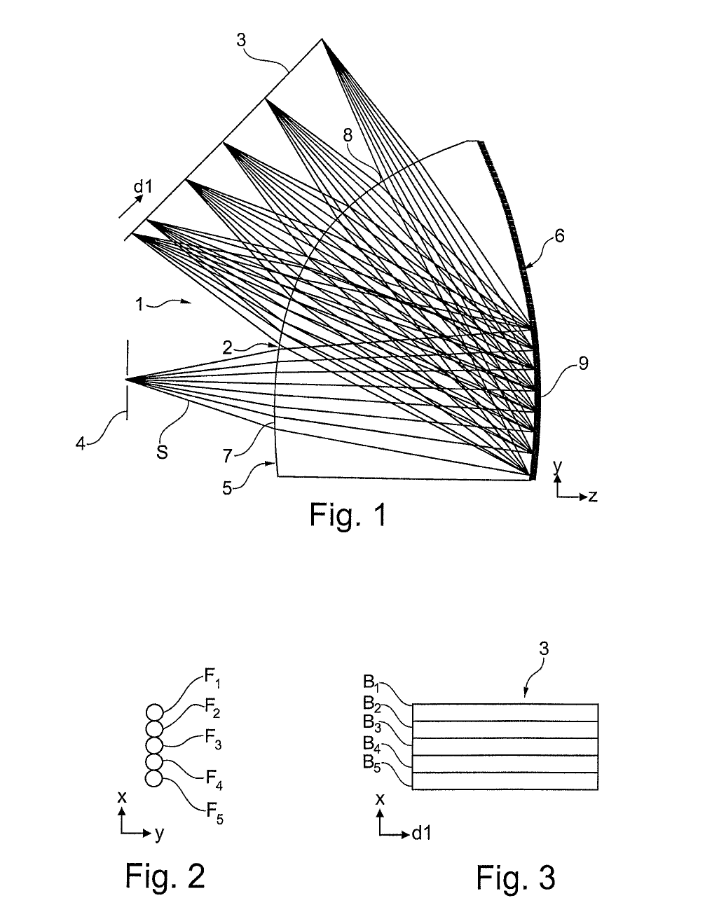

In the embodiment shown in FIG. 1, the spectrometer 1 according to the invention comprises a monolithic transparent body 2, a detector 3 and an entrance slit 4.

The body 2 has a front side 5 and a rear side 6, wherein an entry area 7 and an exit area 8 are formed on the front side 5 and a reflection grating 9 is formed on the rear side 6.

The rear side 6 is formed spherically curved and the grating lines of the reflection grating 9 extend perpendicular to the plane of drawing of FIG. 1, wherein the reflection grating is formed as a blazed diffraction grating (the grating lines in a sectional plane parallel to the plane of drawing of FIG. 1 thus have a saw-tooth profile).

As can be seen from FIG. 1, a beam S, coming from the entrance slit 4, enters the transparent body 2 via the entry area 7 and runs as far as the reflection grating 9. At the reflection grating 9 the beam S is reflected towards the exit area 8, wherein the reflected beam S exits the body 2 via the exit area 8 and impinges on the detector 3, which here for example can be a CCD line. For one thing, when reflected at the reflection grating 9, the reflected beam S is spectrally split (here in the horizontal plane, which corresponds to the plane of drawing). For another, when reflected, the beam S is focused both in the horizontal plane and in the vertical plane (here the plane perpendicular to the plane of drawing) and thus in the plane of the spectral splitting as well as in the plane perpendicular to it, since the rear side 6 is spherically curved. The reflection grating 9 is thus formed as an imaging grating.

The exit area 8 also effects a focusing in the horizontal and in the vertical plane. Furthermore, the exit area 8 serves to compensate for and correct the astigmatism occurring in particular through the reflection at the reflection grating 9. Furthermore, the exit area 8 serves to reduce the spectral curvature of the image field, since the detector 3 as a rule has no curvature but is formed planar. Both of these corrections can be carried out advantageously close to the image field by means of the exit area 8.

In order that the exit area 8 provides this optical effect it is formed as a free-form surface, wherein in particular a curved surface which is neither a sphere nor a rotationally symmetrical asphere is meant by this. The free-form surface can be described using the following formula:

$$z = \frac{{cr}^{2}}{1 + \sqrt{1 - ( 1 + k ) \cdot {c}^{2} {r}^{2}}} + {\sum }_{j = 2}^{66} {C}_{j} {x}^{m} {y}^{n}$$

with j=[(m+n)²+m+3n]/2+1 and r=\sqrt{x²+y²},
wherein in the following table it is indicated for each parameter Cⱼ what value this has and to which xy polynomial it is assigned. Therefore, the value for parameter C₁₃ is −1.1589·10⁴ for x²y². All parameters Cⱼ not indicated in the table are zero.

| | | |
|---|---|---|
| C₄ | x² | 4.3327E |
| C₆ | y² | −8.3984E−02 |
| C₈ | x²y | 5.7990E−03 |
| C₁₀ | y³ | 8.2859E−03 |
| C₁₁ | x⁴ | 3.4591E−04 |
| C₁₃ | x²y² | −1.1589E−04 |
| C₁₅ | y⁴ | −2.5834E−04 |
| C₁₇ | x⁴y | −6.7901E−05 |
| C₁₉ | x²y³ | −3.5178E−06 |
| C₂₁ | y⁵ | 2.2088E−06 |
| C₂₂ | x⁶ | −2.2644E−06 |
| C₂₄ | x⁴y² | 3.0392E−06 |
| C₂₆ | x²y⁴ | −2.5396E−07 |

Assuming that the coordinate origin lies at the vertex of the spherical rear side 6, the free-form surface 5 lies offset in relation to the reflection grating 9 by 0.000 mm in x-direction, by 0.000 mm in y-direction and by −28.242 mm in z-direction, wherein the y-axis extends perpendicularly out of the plane of drawing according to FIG. 1.

The conic constant k is 2.4991 and the concave radius of curvature R of the free-form surface is −7.711 mm, wherein c=1/R.

The spherical rear side has a concave radius of curvature of 37.95 mm.

The spectrometer described here is designed for a spectral range of from 365 to 900 nm, wherein the aperture at the entrance slit can be at most 0.2. The transparent body can be made of plastic, glass or quartz. Its extent from the entry area 7 to the reflection grating 9 can lie in the range 5-30 mm, in particular 5-25 mm and preferably of from 7-20 mm.

By forming the reflection grating 9 as a blazed rear side grating, the blaze maximum is shifted to higher wavelengths, for instance to 350 nm. This is advantageous for using the spectrometer 1 for wavelengths greater than 350 nm.

The material of the transparent body 2 is selected depending on the wavelength range for which the spectrometer 1 is designed. Thus, e.g., special glass such as quartz or calcium fluoride or, e.g., ordinary glass, such as, e.g., BK7, can be used for the transparent body 2.

The reflection grating can have, e.g., 1500 to 2000 lines per mm.

The extent of the split spectrum on the detector 3 (in direction d1) can lie in the range of from 5 to 10 mm, in particular in the range of from 6 to 9 mm.

In the embodiment according to FIG. 1 the entrance slit 4 is represented as a slit. It can however also, for example, be formed by the outlet-side end of an optical fiber.

The spectrometer described in FIG. 1 can be called a single-channel spectrometer.

It can, however, also be used as a multi-channel spectrometer. In this case the entrance slit 4 can, for example, be formed by five ends, lying one on top of the other (in a y-direction), of optical fibers F1-F5. The number of five optical fibers F1-F5 is to be understood only by way of example. It can also be higher, e.g., 5-20 fibers and in particular 10-20 fibers. The detector 3 is then formed as a planar detector (as represented schematically in FIG. 3), wherein the individual channels lie one on top of the other in the y-direction and the spectral splitting for each channel runs in direction d1. The corresponding regions on the detector 3 for each channel are labelled B1 to B5. Due to the good optical imaging properties of the transparent body 2 and in particular its low astigmatism due to the formation of the exit area 8 as a free-form surface, the separation of the beam coming from the optical fibers F1-F5 into the individual regions B1-B5 shown schematically in FIG. 3 is possible, with the result that the desired multi-channel spectrometer can be provided.

In the embodiment described here, the detector surface is approximately 12.5×8 mm (in d1- and x-direction) and the extent of the entrance slit is 6 mm in x-direction and 0.07 mm in y-direction. A resolution with a halfwidth of less than 4 nm can be achieved. The tenth width is less than 5 nm in the centre and less than 6 nm at the edge.

The reflection grating can in particular be formed as a holographic grating which is produced using a holographic standing wave process.

The transparent body 2 and the detector 3 can sit in a common housing (not shown). The slit 4 can be formed in a wall of the housing.

1-13. (canceled)

14. A spectrometer comprising
a detector and
a transparent body which has an entry area and an exit area on a front side of the body and a reflection grating on a rear side of the body,
wherein a beam entering the body via the entry area is reflected at the reflection grating to the exit area and is spectrally split and passes through the exit area and impinges on the detector, and
wherein the rear side is curved at least in the region of the reflection grating in such a way that the beam is focused in a horizontal plane and a vertical plane when it is reflected at the reflection grating.

15. The spectrometer according to claim 14, wherein the beam is focused in the horizontal and vertical planes as it passes through the exit area.

16. The spectrometer according to claim 14, wherein the rear side is spherically curved at least in a region of the reflection grating.

17. The spectrometer according to claim 14, wherein the rear side is formed as a free-form surface at least in a region of the reflection grating.

18. The spectrometer according to claim 15, wherein the rear side is formed as a free-form surface at least in a region of the reflection grating.

19. The spectrometer according to claim 14, wherein the exit area is formed as a free-form surface.

20. The spectrometer according to claim 15, wherein the exit area is formed as a free-form surface.

21. The spectrometer according to claim 16, wherein the exit area is formed as a free-form surface.

22. The spectrometer according to claim 17, wherein the exit area is formed as a free-form surface.

23. The spectrometer according to claim 18, wherein the exit area is formed as a free-form surface.

24. The spectrometer according to claim 14, wherein the entry and exit areas are at a distance from one another on the front side.

25. The spectrometer according to claim 14, wherein the entry area is formed planar.

26. The spectrometer according to claim 14, wherein the entry and exit areas penetrate each other at least partially.

27. The spectrometer according to claim 14, wherein the beam is reflected exactly once at the reflection grating as it passes from the entry area to the exit area in the transparent body.

28. The spectrometer according to claim 14, wherein the body is formed as a monolithic body.

29. The spectrometer according to claim 14, wherein the exit area reduces astigmatism, spectral curvature, or both astigmatism and spectral curvature, of an image field.

30. The spectrometer according to claim 14, wherein the spectrometer is formed as a multi-channel spectrometer and the channels lie one on top of the other in a vertical direction.

31. The spectrometer according to claim 14, wherein the reflection grating is formed as a blazed diffraction grating.
